(19) United States
(12) Patent Application Publication
(10) Pub. No.: US 2009/0292662 A1
(43) Pub. Date: Nov. 26, 2009

(54) TIME-SERIES DATA ANALYZING APPARATUS, TIME-SERIES DATA ANALYZING METHOD, AND COMPUTER PROGRAM PRODUCT

(75) Inventors: Ken Ueno, Tokyo (JP); Ryohei Orihara, Tokyo (JP)

Correspondence Address: Charles N.J. Ruggiero;Ohlandt, Greeley, Ruggiero & Perle, L.L.P., 10th Floor, One Landmark Square, Stamford, CT, 06901-2682, US

(73) Assignee: Kabushiki Kaisha Toshiba

(21) Appl. No.: 12/470,950

(22) Filed: May 22, 2009

(30) Foreign Application Priority Data
May 26, 2008 (JP) 2008-137120

(51) Int. Cl. G06N 5/02

(52) U.S. Cl. 706/46

(57) ABSTRACT

Sets of integrated data including history data and time-invariant data grouped for each analysis target are classified based on an inclusion between an amount of change of a time-varying item included in sets of integrated data and a numerical range expressed by an event sequence and also based on a common time-invariant item, to generate a prediction model in which a prediction-target event sequence expressing an amount of change of the event item included in each set of integrated data after being classified and an amount of time required for reaching the amount of change is associated with the event sequence together with a classification condition related to the classification.

### CROSS-REFERENCE TO RELATED APPLICATIONS

This application is based upon and claims the benefit of priority from the prior Japanese Patent Application No. 2008-137120, filed on May 26, 2008; the entire contents of which are incorporated herein by reference.

### BACKGROUND OF THE INVENTION

1. Field of the Invention

The present invention relates to a time-series data analyzing apparatus, a time-series data analyzing method, and a computer program product that analyze time series data.

2. Description of the Related Art

Conventionally, there have been various techniques for analyzing data that changes with a lapse of time in a time-series manner. For example, JP-A 2007-258731 (KOKAI) discloses a technique in which process state information associated with a state of a process obtained in a time-series manner and test result information for a target product subject to the process are input during a period when each process step constituting the process is being executed, thereby generating a model that represents the relation between a feature quantity of the process and the test result.

Although there is an apparatus that analyzes time-series data such as the above conventional technique, it cannot be understood that there have been provided an apparatus that is sufficiently effective in mechanically estimating the degree of time-series change of an event occurring in a prediction target and time required to the change. For example, in the technical field of maintenance of apparatuses or the like, test data in which aged deterioration of parts is recorded is stored in various databases. However, it is difficult to predict aged deterioration of the parts, unless multiple factors in which restoration history, operation frequency, and difference of application of the parts are compositely connected with each other are taken into consideration. In the time-series analysis according to the conventional technique, a predicted value can be estimated based on quantitative analysis, even if the multiple factors are not clear. However, it is difficult for a human to interpret a prediction model, and it cannot be understood that the prediction model is estimated based on reasonable grounds or reasons.

Also in regular-basis health examination data used in medical and nursing care sectors, physical conditions are different for each person, and alcohol drinking frequency, fitness habits, and food habit are also different. Therefore, it can be considered that effective health guidance becomes possible if medical experts present improvement plans of lifestyle habit, taking these multiple factors into consideration. For example, in a case of improving levels of neutral fat, it can be considered to present an effective improvement plan for the multiple factors based on verification by data analysis, judged by a reasonable combination, such that although drinking of alcohol can be reduced only slightly, the level of neutral fat can be returned to a normal range after two years by increasing exercise frequency to 1.5 times. In the nursing care sector, nursing care services should be provided based on an analysis result of how a change in mental and physical conditions and the nursing care services relates to a change in the degree of need of nursing care, and how the change in mental and physical conditions corresponds to the change in the degree of need of nursing care. However, such an estimate cannot be performed according to the above conventional technique.

### SUMMARY OF THE INVENTION

According to one aspect of the present invention, a time-series data analyzing apparatus includes a first storage unit that stores integrated data obtained by associating time-series data and time-invariant data with respect to a common analysis target for each of a plurality of analysis targets, the time-series data recording an event item quantitatively indicating a predetermined event occurred with a lapse of time, a time-varying item indicating a numerical value of an element related to occurrence of a corresponding event, and date and time of occurrence of the event, and the time-invariant data including one or a plurality of time-invariant items indicating a time-invariant setting content relating to the analysis target; a first generating unit that expands a numerical range of the time-varying item included in a specific set of integrated data to be analyzed, among sets of grouped integrated data for each of the analysis targets, and generates an event sequence expressing the numerical range including an amount of change of the time-varying item included in the set of grouped integrated data for each of other analysis targets; a second generating unit that classifies respective sets of the grouped integrated data based on an inclusion between the amount of change of the time-varying item included in the sets of grouped integrated data and the numerical range expressed by the event sequence and also based on the time-invariant item common to respective sets, and generates a prediction model obtained by associating a prediction-target event sequence with the event sequence together with a classification condition related to the classification, the prediction-target event sequence expressing an amount of change of the event item included in each set of integrated data after being classified and an amount of time required for reaching the amount of change of the event item; and a second storage unit that stores the prediction model.

According to another aspect of the present invention, a time-series data analyzing method includes storing integrated data obtained by associating time-series data and time-invariant data with respect to a common analysis target for each of a plurality of analysis targets, the time-series data recording an event item quantitatively indicating a predetermined event occurred with a lapse of time, a time-varying item indicating a numerical value of an element related to occurrence of a corresponding event, and date and time of occurrence of the event, and the time-invariant data including one or a plurality of time-invariant items indicating a time-invariant setting content relating to the analysis target;

expanding a numerical range of the time-varying item included in a specific set of integrated data to be analyzed, among sets of grouped the integrated data grouped for each of the analysis targets, and generating an event sequence expressing the numerical range including an amount of change of the time-varying item included in the sets of grouped integrated data for each of other analysis targets; and classifying respective sets of the grouped integrated data based on an inclusion between the amount of change of the time-varying item included in the sets of grouped integrated data and the numerical range expressed by the event sequence and also based on the time-invariant item common to respective sets, and generating a prediction model obtained by associating a prediction-target event sequence with the event sequence together with a classification condition related to the classification, the prediction-target event sequence expressing an amount of change of the event item included in each set of grouped integrated data after being classified and an amount of time required for reaching the amount of change of the event item.

A computer program product according to still another aspect of the present invention causes a computer to perform the method according to the present invention.

### BRIEF DESCRIPTION OF THE DRAWINGS

FIG. 1 is a block diagram of a functional configuration of a time-series data analyzing apparatus according to an embodiment of the present invention;

FIG. 2 is a diagram of one example of data stored in a history-data storage unit shown in FIG. 1;

FIG. 3 is a diagram of one example of data stored in a time-invariant-data storage unit shown in FIG. 1;

FIG. 4 is a diagram of one example of integrated data generated from elements of data shown in FIG. 2 and elements of data shown in FIG. 3;

FIG. 5 is a schematic diagram of a candidate event sequence;

FIG. 6 is a schematic diagram of another candidate event sequence;

FIG. 7 is a flowchart of an event-sequence generating process procedure;

FIG. 8 is a schematic diagram of an event sequence for an operation frequency of a part A1;

FIG. 9 is a schematic diagram for explaining branching of an event sequence;

FIG. 10 is a flowchart of a prediction-model generation process procedure;

FIG. 11 is a flowchart of a prediction-result output process procedure;

FIG. 12 is a block diagram of another mode of the embodiment;

FIG. 13 is a block diagram of still another mode of the embodiment;

FIG. 14 is a block diagram of still another mode of the embodiment; and

FIG. 15 is a block diagram of a hardware configuration of the time-series data analyzing apparatus shown in FIG. 1.

### DETAILED DESCRIPTION OF THE INVENTION

Exemplary embodiments of a time-series data analyzing apparatus, a time-series data analyzing method, and a computer program product according to the present invention will be explained below in detail with reference to the accompanying drawings. A mode in which time series data of metal fatigue with age related to metal parts constituting a predetermined apparatus is set as an analysis target is explained below. However, applications of the present invention are not limited thereto.

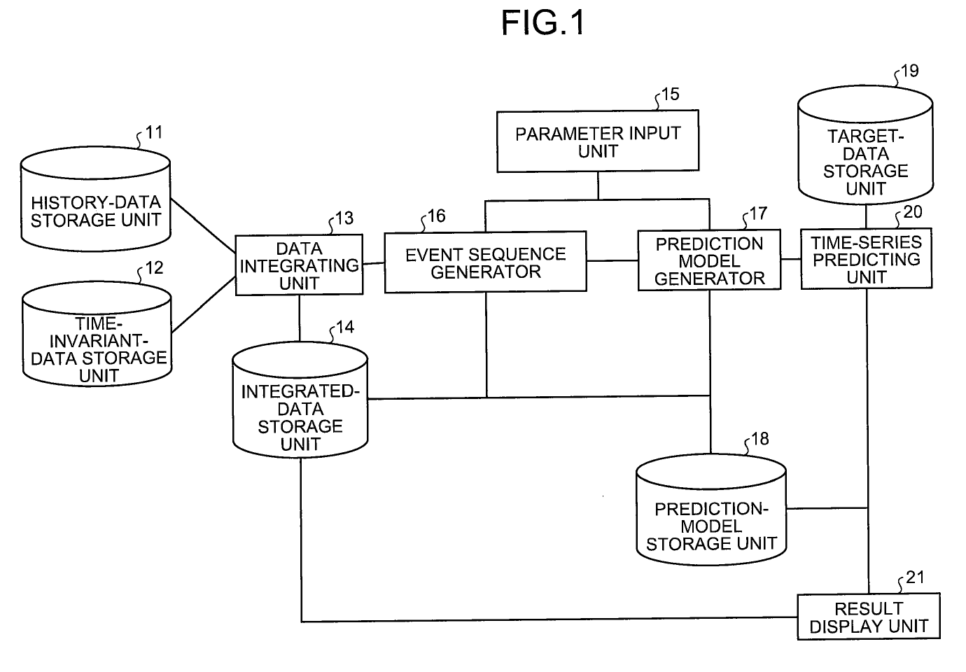

As shown in FIG. 1, the time-series data analyzing apparatus includes a history-data storage unit 11, a time-invariant-data storage unit 12, a data integrating unit 13, an integrated-data storage unit 14, a parameter input unit 15, an event sequence generator 16, a prediction model generator 17, a prediction-model storage unit 18, a target-data storage unit 19, a time-series predicting unit 20, and a result display unit 21.

The history-data storage unit 11 is a database or the like provided in a storage unit 34 described later, and stores history data (time-series data) in which an event item quantitatively indicating an event, which has occurred with a lapse of time in the analysis target, such as parts name (in the case of maintenance sector) or the mental and physical conditions (in the case of medical and nursing care sectors) is recorded together with a time-varying item indicating a quantitative numerical value related to the occurrence of the event and date and time of occurrence of the event. Specifically, the degree of metal fatigue (Levels 1 to 3), the operation frequency per month which is an element of occurrence of metal fatigue, and a restoration date are stored in association with each other as history data.

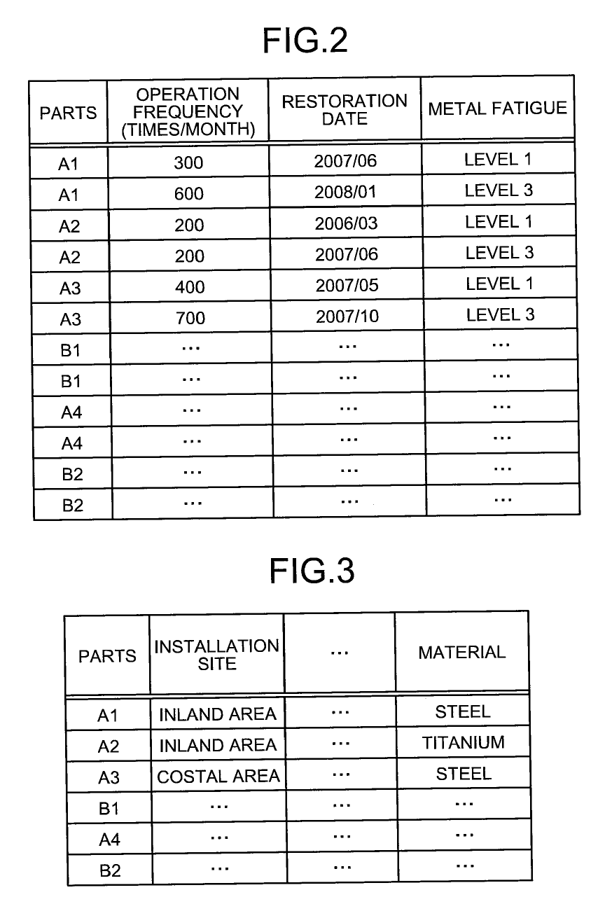

FIG. 2 is a diagram of one example of the history data stored in the history-data storage unit 11. As shown in FIG. 2, the history data includes Levels 1 to 3 quantitatively indicating the metal fatigue (event) having occurred with the lapse of time, the operation frequency (time-varying item) per month which is the element of occurrence of metal fatigue, and the restoration date corresponding to the date and time of occurrence of the event, for the respective parts to be analyzed. The history data is not limited to the example shown in FIG. 2. For example, when there is a plurality of types of time-varying items related to the occurrence of the event, these types of time-varying items can be included therein.

The time-invariant-data storage unit 12 is a database or the like provided in the storage unit 34, and stores time-invariant data items (time-invariant items) associated with the respective analysis targets stored in the history-data storage unit 11. FIG. 3 is a diagram of one example of data (time-invariant data) stored in the time-invariant-data storage unit 12. As shown in FIG. 3, the time-invariant data stores installation site and material in association with each other, as the time-invariant items associated with the respective parts (A1, A2, A3, . . . ) shown in FIG. 2. The time-invariant data is not limited to the example shown in FIG. 3.

The data integrating unit 13 couples the data stored in the history-data storage unit 11 and the time-invariant-data storage unit 12 for a common analysis target (parts name) to generate one integrated data, and stores the integrated data in the integrated-data storage unit 14.

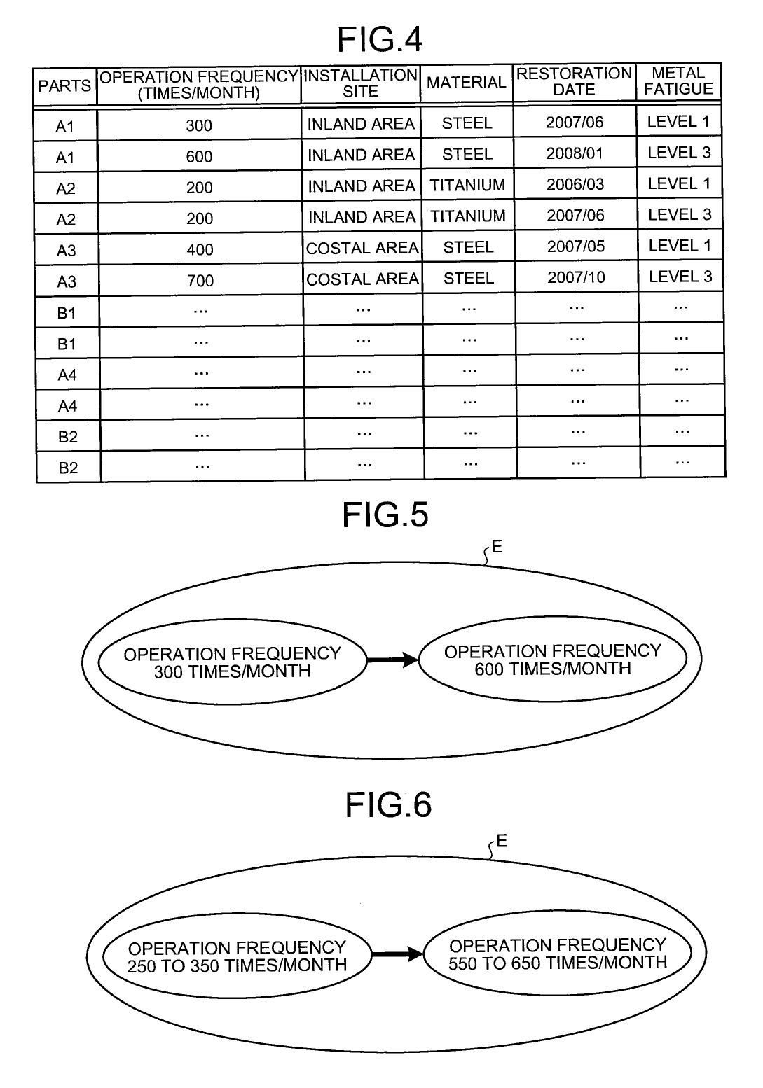

FIG. 4 is a diagram of one example of the integrated data generated from respective elements of data in the history-data storage unit 11 shown in FIG. 2 and respective elements of data in the time-invariant-data storage unit 12 shown in FIG. 3. As shown in FIG. 4, the integrated data is obtained by integrating the history data stored in the history-data storage unit 11 and the time-invariant data stored in the time-invariant-data storage unit 12 for the common parts name, in which the operation frequency (number of times/month), installation site, material, restoration date, and metal fatigue are associated with each other for each parts.

The integrated-data storage unit 14 is a database or the like provided in the storage unit 34, and stores the integrated data generated by the data integrating unit 13.

The parameter input unit 15 inputs change granularity, prediction target item, and minimum number of events to the event sequence generator 16 and the prediction model generator 17, as parameters to be used for a process performed by the event sequence generator 16 and the prediction model generator 17.

The “change granularity” is a parameter that specifies an expanded amount of a relaxed range described later. The “prediction target item” is a parameter that specifies items to be predicted in the prediction model described later, among respective items (operation frequency, installation site, material, restoration date, and metal fatigue) included in the integrated data. The “minimum number of events” is a parameter that specifies a minimum value of a leaf node classified in a decision tree classification model described later.

When the respective parameters of change granularity, prediction target item, and minimum number of events are prestored in the storage unit 34 or the like, the parameter input unit 15 reads the respective parameters from the storage unit 34, and inputs the parameters to the event sequence generator 16 and the prediction model generator 17. When these parameters are input via an operating unit 36 or a communication unit 37, the parameter input unit 15 inputs the input parameters to the event sequence generator 16 and the prediction model generator 17, respectively.

The event sequence generator 16 receives an input of the change granularity and prediction target item as the parameter, and selects at least two elements of integrated data for the same parts name (analysis target) to group these items. The event sequence generator 16 rearranges the grouped integrated data in order of time series based on the restoration date in the history data included in the integrated data. Further, the event sequence generator 16 sequentially expands a numerical range of the time-varying item included in a chunk of a specific part, of sets of grouped integrated data (hereinafter, abbreviated as “chunk”), thereby generating a candidate event sequence representing the numerical range.

Generation of the candidate event sequence is explained below based on the integrated data shown in FIG. 4. It is assumed that the parameter input unit 15 specifies “granularity=50” as the change granularity, and “metal fatigue” and “restoration date” as the prediction target item.

Regarding one part in the integrated data stored in the integrated-data storage unit 14, the event sequence generator 16 selects an item including a numerical value included in an entry regarding this part sequentially from the left. The event sequence generator 16 then arranges the integrated data in order of time course so that a value of the selected item changes on a time axis.

In the case of integrated data shown in FIG. 4, regarding a part A1, the operation frequency was 300/month as of June 2007, whereas the operation frequency changed to 600/month as of January 2008. Therefore, the event sequence generator 16 rearranges the set of these data in order of time course. In the integrated data shown in FIG. 4, a state after the items are rearranged in order of time course for the same parts is shown.

Subsequently, the event sequence generator 16 expands a range of the operation frequency of the data set (hereinafter, “chunk”) of the same parts by using the change granularity input from the parameter input unit 15, to generate the candidate event sequence. Specifically, the event sequence generator 16 expands the range of the operation frequency by using the following equation (1). “x” denotes a variable assigned with each operation frequency included in the data chunk, λ denotes the change granularity, and φ denotes a variable (initial value is 0) incremented in a range enlarging process described later. The range of the operation frequency calculated according to the following equation (1) is referred to as “relaxed range” R.

R=[x−λ×φ, x++λ×φ] (1)

In the chunk regarding the part A1, because the operation frequency is “300” and “600”, when the equation (1) is calculated under conditions of change granularity=50 and (φ=0, the operation frequency (relaxed range) in the case of x=300 becomes 300 (times/month), and the operation frequency (relaxed range) in the case of x=600 becomes 600 (times/month). That is, in the case of first time, that is, φ=0, there is no alleviation by the range, and thus it is determined whether other elements of data satisfy these conditions for the operation frequency itself.

FIG. 5 is a schematic diagram of the candidate event sequence in the case of relaxed range being 300 (times/month) and 600 (times/month). In FIG. 5, reference letter E denotes the candidate event sequence, which includes a node for the operation frequency (relaxed range) of 300 (times/month) and a node for operation frequency (relaxed range) of 600 (times/month). Arrow in FIG. 5 denotes a timewise sequence of the respective nodes, and means that the state has changed from the node at an arrow source to the node at an arrow destination. In the following explanations, the node at the arrow source is referred to as “starting node”, and the node at the arrow destination is referred to as “ending node”. The relaxed range in the respective nodes is simply referred to as range of the starting node and range of the ending node.

When the candidate event sequence is generated for one part, the event sequence generator 16 determines whether there is one or more chunks (parts) having record data corresponding to the relaxed range (the range of the starting node and the range of the ending node) of the candidate event sequence in the integrated data, other than the chunk which is a generation source of the candidate event sequence. In the case of the candidate event sequence in FIG. 5, the event sequence generator 16 determines that there is no part other than the part A1, in which the operation frequency changes from 300 times/month to 600 times/month.

When having determined that there is no part corresponding to the candidate event sequence other than the part, which is the generation source of the candidate event sequence, the event sequence generator 16 increments the value of φ by one to gradually expand the relaxed range, and compares again a condition of the relaxed range of the candidate event sequence with the operation frequency included in the respective chunks.

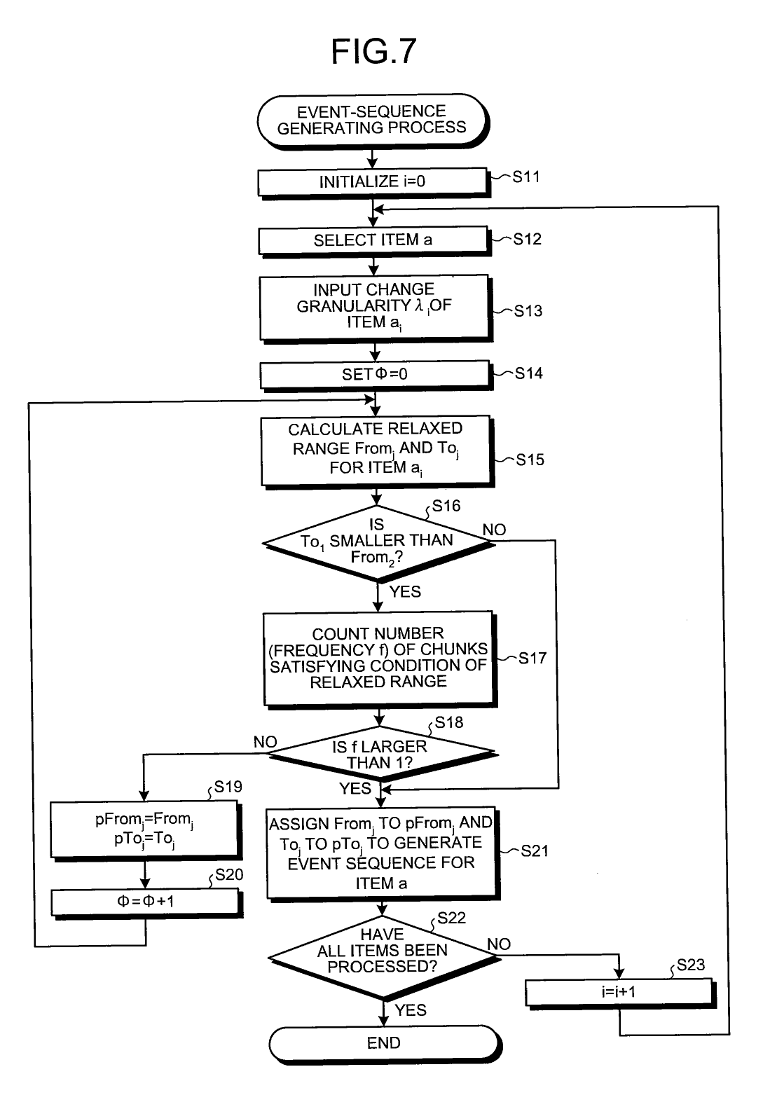

When φ=1, the relaxed range in the case of x=300 becomes the operation frequency of from 250 to 350 (times/month), and the relaxed range in the case of x=600 becomes the operation frequency of from 550 to 650 (times/month). FIG. 6 is a schematic diagram of the candidate event sequence in this case. Also in the case of candidate event sequence E shown in FIG. 6, because there is no chunk, in which the relaxed range changes from 250 to 350 times/month to 550 to 650 times/month, other than the part A1, the event sequence generator 16 sets φ to 2, and further expands the relaxed range. When having determined that there is one or more chunks corresponding to the candidate event sequence other than the chunk, which is the generation source of the candidate event sequence, the event sequence generator 16 adopts (generates) the candidate event sequence as an event sequence. An operation of the event sequence generator 16 related to generation of the event sequence is explained with reference to a flowchart in FIG. 7.

It is assumed that the respective parts included in the integrated data have been grouped.

The event sequence generator 16 first initializes index i, which is an index at the time of selecting each item in the integrated data to 0 (Step S11). Subsequently, one part (chunk) of the integrated data stored in the integrated-data storage unit 14 is set as a processing target, and the event sequence generator 16 selects item aᵢ including a numerical value from an entry for the part (Step S12). “aᵢ” means the i-th item of the items including the numerical value in the entries. At the time of selecting the item at Step S12, the item can be sequentially selected from the left of the entry or can be sequentially selected from the right.

Upon reception of change granularity λᵢ of item aᵢ selected at Step S12 from the parameter input unit 15 (Step S13), the event sequence generator 16 sets φ to 0 for calculating the equation (1) (Step S14).

Subsequently, the event sequence generator 16 calculates the relaxed range for item aᵢ included in the chunk to be processed as Fromⱼ=xⱼ−(φ×λᵢ), Toⱼ=xⱼ+(φ×λᵢ) based on the equation (1) (Step S15). Subscript j is an index for identifying the relaxed range for item aᵢ, which is varied in a time-series manner. For example, in the case of a chunk for the part A1, the relaxed range for item aᵢ included in data of restoration date June 2007, that is, the range of the starting node is expressed by From₁=x₁−(φ×λᵢ) to To₁=x₁+(φ×λᵢ). The relaxed range for item aᵢ included in data of restoration date January 2008, that is, the range of the ending node is expressed by From₂=x₂−(φ×λᵢ) to To₂=x₂+(φ×λᵢ).

The event sequence generator 16 compares To₁ of the starting node with From₂ of the ending node obtained from a calculation result at Step S15 and determines whether To₁<From₂ to determine whether there is a contradiction in the time series sequence (Step S16). When it is determined that To₁>From₂, that is, it is determined that there is a contradiction in the time series sequence (NO at Step S16), control proceeds to Step S21.

At Step S16, when it is determined that To₁<From₂, that is, when it is determined that there is no contradiction in the time series sequence (YES at Step S16), the event sequence generator 16 sets the calculation result at Step S15 as a provisional condition of the event sequence and counts the number (frequency f) of chunks (parts) satisfying the condition (Step S17). Subsequently, the event sequence generator 16 determines whether the value of f counted at Step S17 is larger than 1 (Step S18).

When item aᵢ for the chunk of the part A1 indicates the operation frequency, From₁=300, To₁=300, From₂=600, and To₂=600 when φ=0, and thus it is determined that there is no contradiction at Step S16. In this case, because there is no part satisfying the condition other than the part A1, the event sequence generator 16 counts as f=1 at Step S17. At this time, because f>1 is not satisfied, the event sequence generator 16 cannot satisfy the condition at subsequent Step S18 (NO at Step S18), and control proceeds to Step S19.

At Step S19, the event sequence generator 16 assigns the value of Fromⱼ to pFromⱼ, and also assigns the value of Toⱼ to pToⱼ (Step S19). Subsequently, the event sequence generator 16 increments the value of φ by 1 (Step S20), and returns to the process at Step S15.

When item aᵢ for the chunk of the part A indicates the operation frequency, the calculation of the relaxed range when φ=1 is performed, assuming that φ=0+1, then, From₁=250, To₁=350, From₂=550, and To₂=650. In this case, because To₁=350<From₂=550, it is determined that there is no contradiction in the time series sequence at Step S16. The event sequence generator 16 sets the relaxed range as the condition of the candidate event sequence, and counts up the number of chunks satisfying the condition of the candidate event sequence at Step S17. Also in this case, because only the part A1 having x₁=300 and x₂=600 satisfies the condition and the frequency is f=1, the event sequence generator 16 performs the process of “NO at Step S18→Step S20”, and returns to the process at Step S15.

At Step S20, when φ=1+1, because the calculation result at Step S15 is From₁=200, To₁=400, From₂=500, and To₂=700, it is determined that there is no contradiction at Step S16. Because the relaxed range is expanded, not only the part A1 but also the chunk of a part A3 satisfies the condition of the candidate event sequence. Therefore, the frequency f counted at Step S17 becomes 2. In this case, because f>1 (YES at Step S18), control proceeds to Step S21.

The event sequence generator 16 respectively assigns the value of pFromⱼ to Fromⱼ and the value of pToⱼ to Toⱼ at Step S21 to generate the event sequence for item aᵢ (Step S21). Subsequently, the event sequence generator 16 determines whether all the items including the numerical value, of the entry for the part to be processed, have been selected. When having determined that there is an item not selected (NO at Step S22), the event sequence generator 16 increments the value of i by 1 (Step S23), to select the next item at Step S12.

On the other hand, at Step S22, when having determined that all the items including the numerical value have been selected (YES at Step S22), the event sequence generator 16 finishes the process. By performing the process, the event sequence for all the items including the numerical value is generated with respect to the part to be processed.

The chunk for which the event sequence is to be generated can be predetermined or can be selected at random. Alternatively, the event sequence can be generated for the respective chunks.

Referring back to FIG. 1, the prediction model generator 17 generates a prediction model for predicting a future state of the prediction target, designating the event sequence generated by the event sequence generator 16 and the time-invariant item included in the integrated data stored in the integrated-data storage unit 14 as components thereof. A generation example of the prediction model using the decision tree classification model is explained below.

The prediction model generator 17 tests whether all the elements of data in the integrated data satisfy the condition of the event sequence generated by the event sequence generator 16. When determining that the data satisfies the condition, the prediction model generator 17 sorts out parts set at the lower left of the node of the event sequence, and when determining that the data does not satisfy the condition, the prediction model generator 17 sorts out the parts set at the lower right thereof.

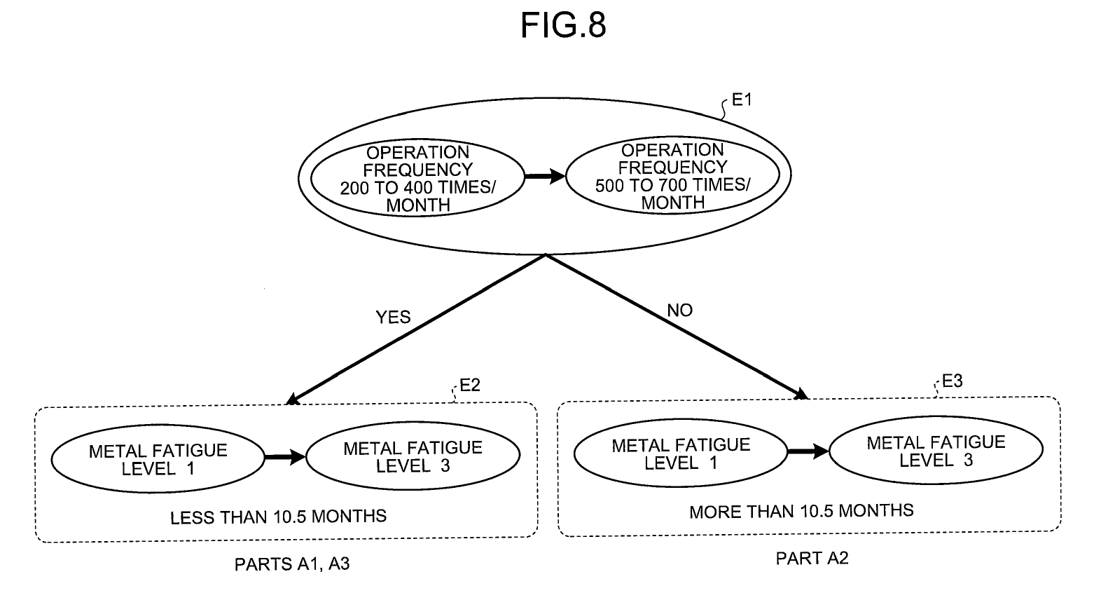

FIG. 8 is a schematic diagram of the event sequence for the operation frequency of the part A1 mentioned above. The starting node of event sequence E1 has the relaxed range of the operation frequency of from 200 to 400 times/month, and the ending node thereof has the relaxed range of the operation frequency of from 500 to 700 times/month. In this case, the prediction model generator 17 specifies parts A1 and A3 as the chunks corresponding to the ranges of the starting node and ending node, and specifies a part A2 as the chunk not corresponding to these ranges.

Because the metal fatigue and restoration date have been specified as the prediction target item by the parameter input unit 15, the prediction model generator 17 respectively arranges node E2 relating to the metal fatigue of parts A1 and A3 at the lower left of the event sequence node, and arranges node E3 relating to the metal fatigue of the part A2 at the lower right of the node. In the following explanations, the node for the prediction target item is referred to as prediction-target event sequence.

The prediction model generator 17 respectively calculates time information required for changing the state of metal fatigue, and provides the time information to the corresponding prediction-target event sequence. The “time information required for changing” means an amount of time required obtained by calculating statistics such as a mean value, a medium value, or a mode value of the time required by the respective parts to be predicted at each branch destination and further calculating the statistic of these values, and designating the calculated value as a boundary value.

In FIG. 8, an example in which the mean value is set as the statistic is shown as a specific example. In this case, the amount of time required for the change of metal fatigue in prediction-target event sequence E2 is 6 months obtained by averaging intervals 7 months and 5 months between the restoration dates for respective parts A1 and A3 in the integrated data shown in FIG. 4. Further, the amount of time required for the change of metal fatigue in prediction-target event sequence E3 is 15 months, which is the interval between the restoration dates for the part A2 in the integrated data shown in FIG. 4. Therefore, the boundary value between prediction-target event sequences E2 and E3 becomes a mean value 10.5 months of 6 months and 15 months. Accordingly, the prediction model generator 17 designates the boundary value as the time information, and respectively provides “less than 10.5 months” to prediction-target event sequence E2 and “equal to or more than 10.5 months” to prediction-target event sequence E3. E2 and E3 are the event sequences expressing a change from metal fatigue level 1 to level 3; however, in event sequence E2, metal fatigue may change from level 1 to level 3 and in event sequence E3, metal fatigue can possibly change from level 2 to level 3 depending on the data. In this case, respective mean values are calculated by using appropriate data corresponding to the change of the respective levels, which are then provided to event sequences E2 and E3 as the time information.

The prediction model generator 17 then determines whether the branched event sequence can be further branched based on the minimum number of cases input from the parameter input unit 15. Referring to other items of parts A1 and A3 of prediction-target event sequence E2 shown in FIG. 8, it is recognized that the material of these parts is the same steel, but is used in a different installation site (see FIG. 4). At this time, when it is assumed that the minimum number of cases input from the parameter input unit 15 is “1”, because two parts of parts A1 and A3 are sorted at the lower left node, the prediction model generator 17 determines that the installation site can be further divided.

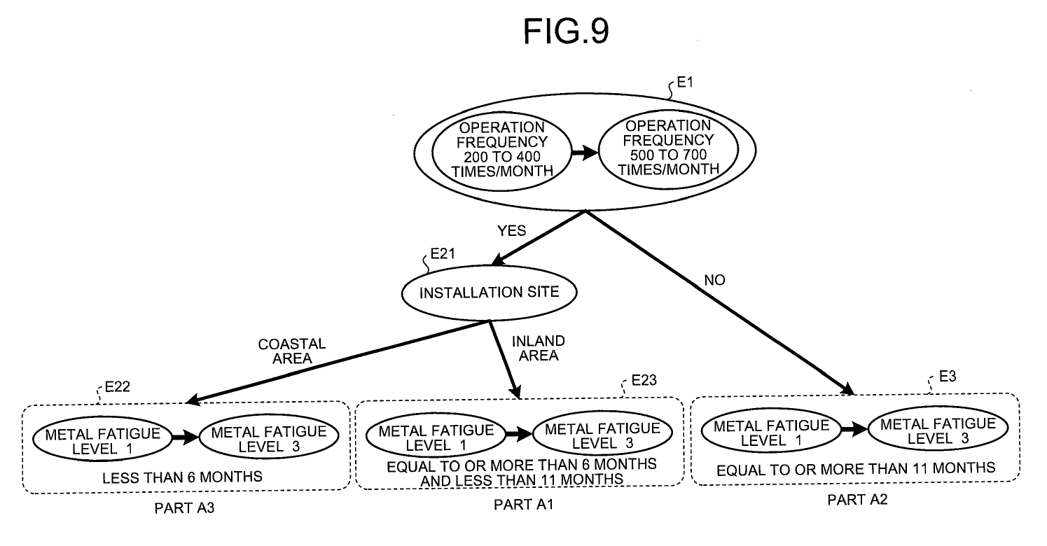

The item itself of the installation site is the time-invariant item; however, as a characteristic of the present embodiment, not only the history data but also the time-invariant item can be included in the prediction model. However, when the minimum number of cases of the parts set at the time of reaching the final branch destination is limited to 2 to generate a more general decision tree model, addition of more items does not have to be performed. When the prediction model is further detailed for the item of installation site, as shown in FIG. 9, an upper part of the corresponding prediction-target event sequence, that is, in this case, node E21 for the installation site is arranged at the lower left of the event sequence E1, and the node E21 is branched to prediction-target event sequence E22 regarding metal fatigue of the part A3 and prediction-target event sequence E23 regarding metal fatigue of the part A1.

The prediction model generator 17 also calculates the boundary value between the branched event sequences and provides the boundary value to the respective prediction-target event sequences as the time information. In the case of the configuration shown in FIG. 9, the amount of time required for the change of metal fatigue in prediction-target event sequence E22 branched to the lower left is a restoration interval of 5 months for the part A3 in the integrated data shown in FIG. 4. Further, the amount of time required for the change of metal fatigue in prediction-target event sequence E23 branched to the lower middle is a restoration interval of 7 months for the part A1 in the integrated data shown in FIG. 4. Therefore, the boundary value between prediction-target event sequences E22 and E23 becomes 6 months, which is a mean value of 5 months and 7 months. Because the amount of time required for the change of metal fatigue in prediction-target event sequence E3 branched to the lower right is a restoration interval of 15 months for the part A2 in the integrated data shown in FIG. 4, the boundary value between prediction-target event sequences E23 and E3 is 11 months, which is a mean value of 7 months and 15 months.

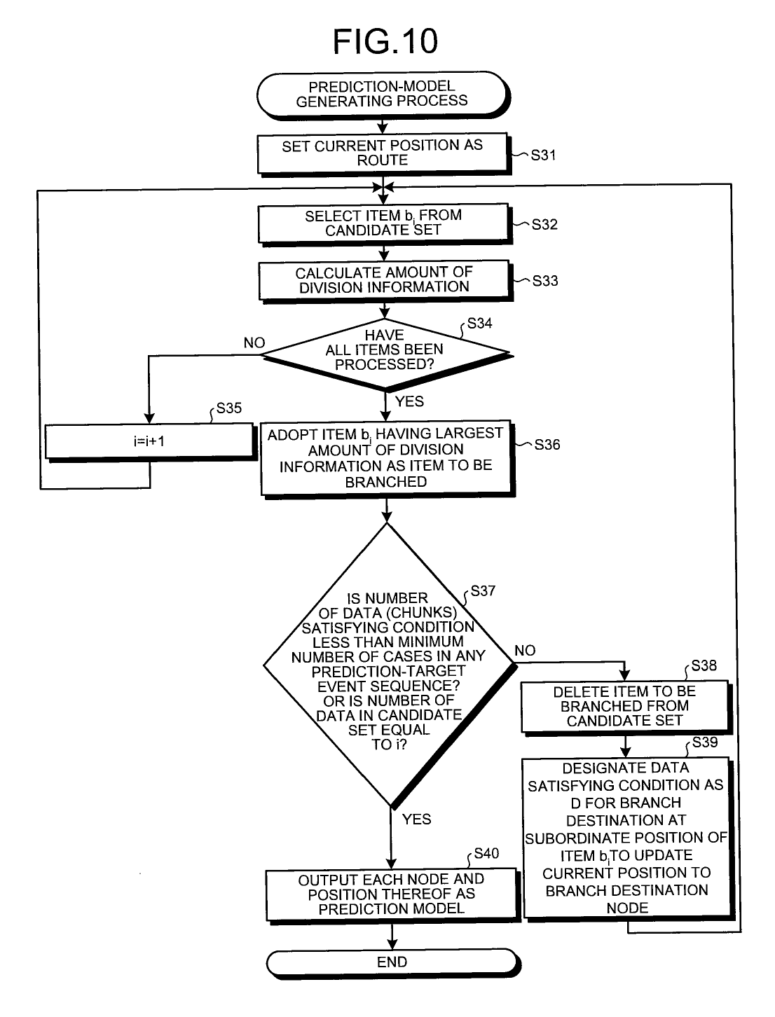

To predict a future value of new data by using the decision tree (prediction model) generated in this manner, parts data to be predicted is input from an uppermost node E1 in the decision tree and the nodes are traced based on the condition specified by the respective branched items, thereby enabling to predict a future condition (in the case of FIG. 9, metal fatigue and approximate amount of time required until reaching the condition) of the prediction target item from the prediction-target event sequence arrived finally. An operation of the prediction model generator 17 related to generation of the prediction model in the present embodiment is shown in FIG. 10. An operation of the prediction model generator 17 is explained with reference to FIG. 10.

FIG. 10 is a flowchart of a prediction-model generation process procedure executed by the prediction model generator 17. The prediction model generator 17 sets the current position as a route (Step S31). The “route” represents a route node of the decision tree constituting the prediction model, and specifically, it is a node of the event sequence generated by the event sequence generator 16. Subsequently, the prediction model generator 17 selects item bᵢ from the event sequence included in the integrated data or a candidate set of the time invariant items, that is, the chunk of the respective parts (Step S32), and calculates an amount of division information from data set D of item b₁ and the event sequence (route node) of item bᵢ (Step S33). The amount of division information (gain ratio, Gain_Ratio) can be calculated according to, for example, the following equation (2).

$$Gain\_Ratio ( B , X ) = \frac{Gain ( B , X )}{{\sum }_{v ∈ Val ( B )} \frac{\vert {X}_{v} \vert}{\vert X \vert} {log}_{2} \frac{\vert {X}_{v} \vert}{\vert X \vert}} \qquad ( 2 )$$

In the equation (2), B denotes an item, and X denotes data set for B. Further, v denotes a value of an arbitrary item, and Val(B) denotes a set of all values that can be taken by B. When the value of Val(B) is a numerical value, the candidate set is branched into groups as the event sequences by using the boundary value, thereby branching the candidate set from the current position, and the range of the value indicated by the branched group is regarded as one item. Xv denotes the data set of the event sequence at the branch destination divided by A=v. |Xv| denotes the number of data included in data set Xv. C denotes the prediction target item, and j denotes the number of types of the value taken by the prediction target item.

In the equation (2), Gain (B, X) denotes a gain of B, that is, an index indicating how much the amount of information (uncertainty) decreases before and after branched item B is arranged, which is derived according to the following equations (3) to (5). In the case of an example of metal fatigue, E2 and E3 in FIG. 8 and E21, E22, and E23 in FIG. 9 generated by the event sequence generator 16 correspond to Cⱼ in the equation (5).

Gain(B, X)=I(B, X)−I(X) (3)

$$\begin{matrix}I ( B , X ) = {\sum }_{v = 1}^{n} \frac{\vert {X}_{v} \vert}{\vert X \vert} \cdot I ( {X}_{v} ) & ( 4 ) \\ I ( X ) = - {\sum }_{j = 1}^{k} \frac{\vert {C}_{j} \vert}{\vert X \vert} {log}_{2} \frac{\vert {C}_{j} \vert}{\vert X \vert} bit & ( 5 )\end{matrix}$$

The prediction model generator 17 evaluates all items including the item of the event sequence generated by the event sequence generator 16 based on the amount of division information Gain_Ratio(B, X) obtained by the equation (2).

Subsequently, the prediction model generator 17 determines whether the process at Step S33 has been executed with respect to all the items included in the integrated data (Step S34). When having determined that there is an unprocessed item (NO at Step S34), the prediction model generator 17 increments the value of i by 1 (Step S35), and returns to Step S32 to execute the process for the next item to be processed.

On the other hand, at Step S34, when having determined that the process at Step S33 has been executed to all the items (YES at Step S34), the prediction model generator 17 adopts an item having the largest amount of division information, of the amount of division information calculated at Step S33, as an item to be branched, and arranges the node of the item to be branched at the current position (Step S36).

When having determined that the number of data sets satisfying the condition, that is, the number of chunks satisfying the condition is not less than the minimum number of cases in any prediction-target event sequence (NO at Step S37), the prediction model generator 17 newly updates the data set and the current position for all the branch destinations of the item to be branched, and removes the item to be branched adopted at Step S36 from the candidate set (Step S38). The prediction model generator 17 then designates the data set satisfying the condition of item bᵢ as D for the branch destination at a subordinate position of item bᵢ to update the current position to a branch destination node (Step S39), and returns to the process at Step S32.

The prediction model generator 17 recurrently repeats the process, and repeats the process from Step S32 to Step S39 until all the items have been tried as the item to be branched or until the number of data included in the data set at the branch destination becomes less than the minimum number of cases. When having determined that all the items have been tried as the item to be branched or the number of data included in the data set at the branch destination is less than the minimum number of cases (YES at Step S37), the prediction model generator 17 outputs the item to be branched arranged so far and the position thereof as the prediction model (Step S40), to finish the process.

When there is an item to be branched having the same amount of division information, a plurality of prediction models is output, leaving multiple possibilities. When there is no item to be branched having the same amount of division information, one model is generated. After having generated the prediction model for each item bᵢ, the prediction model generator 17 evaluates the respective prediction models regarding how accurately all the data sets could be predicted by using, for example, the following equation (6).

Error Rate=Number of data mispredicted/number of all elements of data (6)

Error Rate, recall ratio, and relevance ratio can be considered as a reference of evaluation; however, the simplest error rate is adopted in the equation (6). The prediction model generated by the prediction model generator 17 and the value of an evaluation result are stored in the prediction-model storage unit 18. When a plurality of prediction models is generated by the prediction model generator 17, the result display unit 21 can display the prediction models, for example, in descending order of error rate.

The prediction-model storage unit 18 is a database or the like included in the storage unit 34, and stores the prediction model generated by the prediction model generator 17 and the value of the evaluation result in association with each other.

The target-data storage unit 19 stores data of a predetermined prediction target. For example, the target-data storage unit 19 stores parts to be predicted, history data (such as the operation frequency (times/month), restoration date, or metal fatigue) of the parts, and the time-invariant data (such as the installation site or material).

The time-series predicting unit 20 receives an input of the data of the prediction target stored in the target-data storage unit 19, and uses the prediction model stored in the prediction-model storage unit 18 to predict a future state of the prediction target regarding the predetermined prediction target item. For example, when a part A5 is newly input as the prediction target, if it is predicted that the operation frequency will change from 500 times/month to 700 times/month based on the past trend according to a method such as a regression formula, and when the installation site of the part A5 is inland area, the material thereof is aluminum alloy, and the restoration date is Apr. 1, 2007, information indicating that the metal fatigue will occur equal to or more than 6 months and less than 11 months, that is, from October 2007 to March 2008 is derived as a prediction result. It indicates to reach the branch destination node at the lower middle in FIG. 9 (prediction-target event sequence E23), and it means that the same result as that of the part A1 is predicted.

The result display unit 21 displays the prediction result derived from the prediction model by the time-series predicting unit 20 on a display unit 35 described later. The result display unit 21 also displays the prediction model stored in the prediction-model storage unit 18 on the display unit 35 in response to an operation by a user via the operating unit 36 described later. When the prediction models are stored in the prediction-model storage unit 18, for example, the result display unit 21 can display the prediction model in descending order of error rate.

The result display unit 21 reads the data set (chunk) corresponding to the prediction-target event sequence included in the prediction model from the integrated-data storage unit 14 to display the data set on the display unit 35 in response to the operation via the operating unit 36.

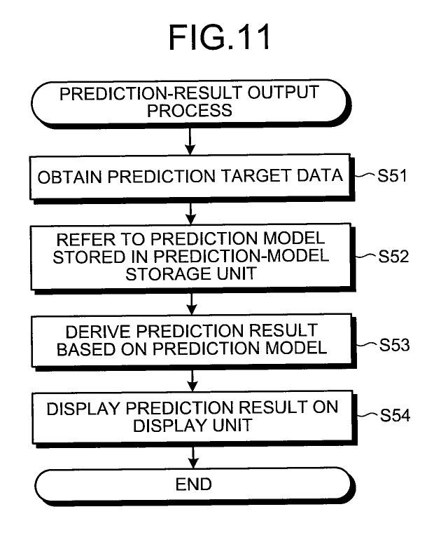

FIG. 11 is a flowchart of a process procedure (prediction result output process) related to output of the prediction result executed by the time-series predicting unit 20 and the result display unit 21. The time-series predicting unit 20 first obtains the prediction target data from the target-data storage unit 19 (Step S51). Subsequently, the time-series predicting unit 20 refers to the prediction model stored in the prediction-model storage unit 18 (Step S52), to trace the nodes corresponding to the prediction target data from the uppermost node in the prediction model based on the condition specified by the respective items to be branched, thereby deriving the item in the event sequence finally reached as the prediction result (Step S53).

When the prediction models are stored in the prediction-model storage unit 18, a prediction model having higher value of the evaluation result can be used, or other prediction models or all the prediction models can be used. When a specific prediction model is selected by the user based on the prediction model displayed by the result display unit 21, the selected prediction model is used to derive the prediction result.

Subsequently, the result display unit 21 displays the prediction result derived at Step S53 on the display unit 35 (Step S54), and the process is finished.

As described above, according to the present embodiment, the respective sets of the grouped integrated data are classified for each analysis target based on an inclusion with the numerical range expressed by the event sequence and are classified based on the common time-invariant item. The prediction model is generated by associating the prediction-target event sequence expressing an amount of change of the event item included in each set of integrated data after being classified and the amount of time required for reaching the amount of change with the event sequence, together with the classification condition. Accordingly, by using the prediction model, the degree of time-series change of the event occurring for the prediction target and the amount of time required for reaching the change can be estimated.

Accordingly, a change in the prediction target on the future time axis can be known based on the time-series record of various events in the quality control or maintenance sector, and the degree of change and a changing process can be estimated based on the various records, thereby enabling to improve the operating effectiveness and safety.

In the present embodiment, the history-data storage unit 11 and the time-invariant-data storage unit 12 are independently held; however, the present invention is not limited thereto. For example, only the data obtained by integrating the data contents of the history-data storage unit 11 and the time-invariant-data storage unit 12 (analysis target data) can be held.

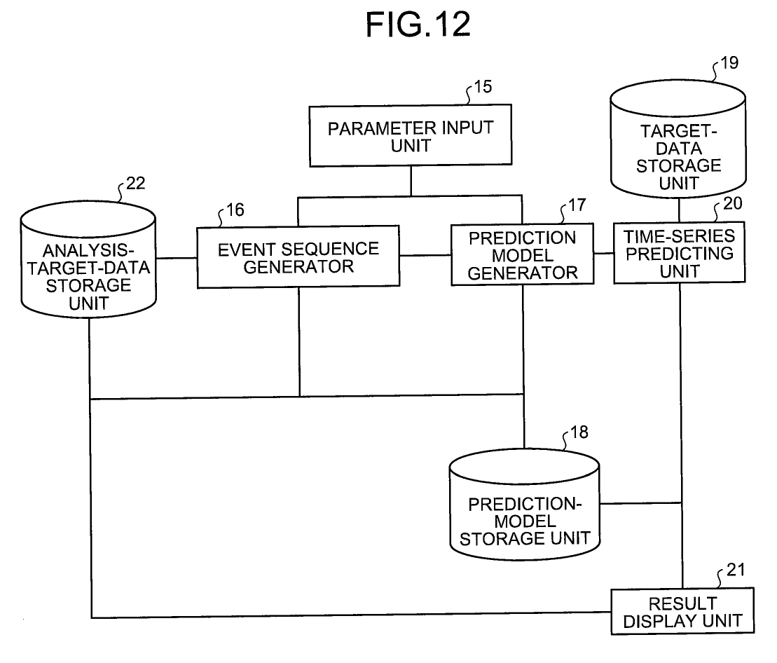

FIG. 12 depicts a configuration holding only the analysis target data as another mode of the present embodiment. In FIG. 12, an analysis-target-data storage unit 22 stores the analysis target data. Because the analysis target data has substantially the same contents of items as those of the integrated data, the data integrating unit 13 and the integrated-data storage unit 14 shown in FIG. 1 are not required, and the event sequence generator 16, the prediction model generator 17, and the result display unit 21 refer to the analysis-target-data storage unit 22.

In the present embodiment, the prediction target data is held in the target-data storage unit 19, however, the present invention is not limited thereto, and the prediction target data can be directly input from an actual part (for example, sensor).

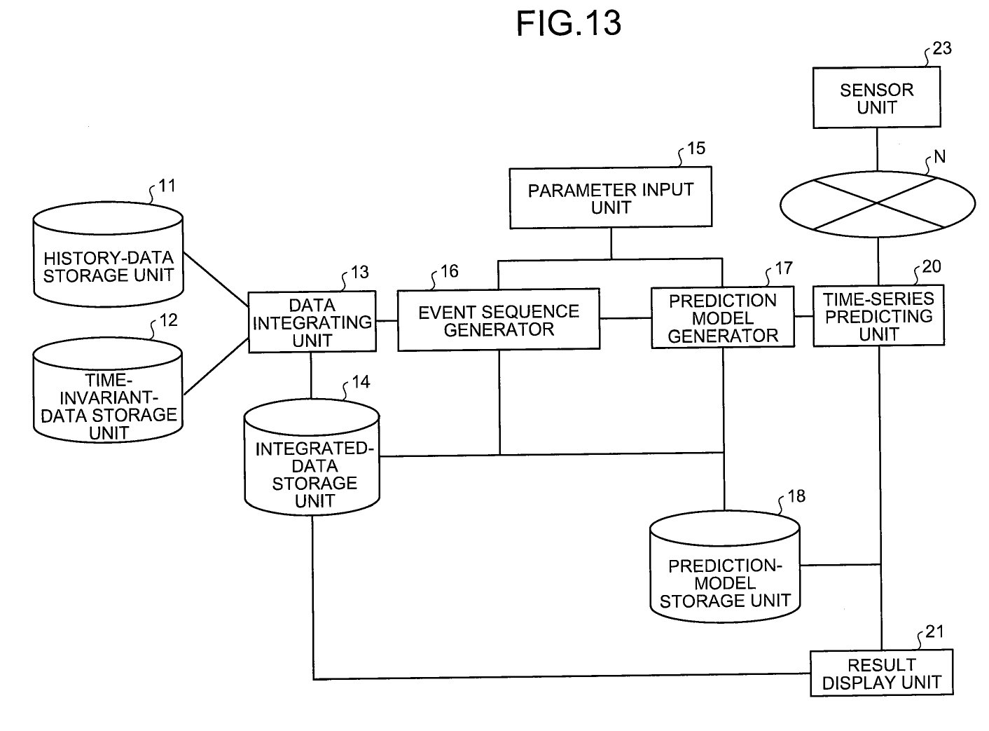

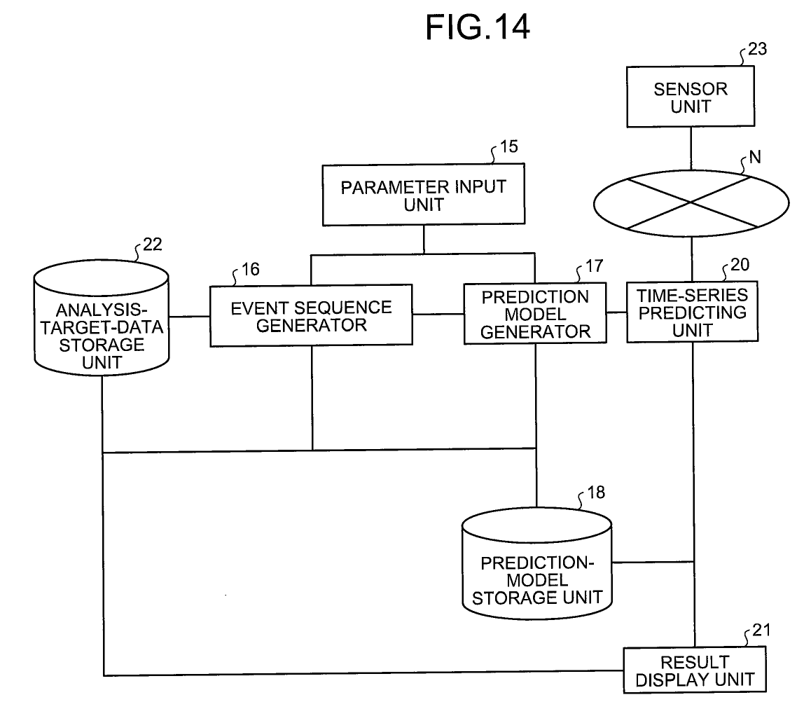

FIG. 13 depicts a configuration in which the prediction target data is directly input, as another mode of the present embodiment. In FIG. 13, a sensor unit 23 is a part to be predicted, and data output from the sensor unit 23 is input to the time-series predicting unit 20 as the prediction target data via a network N. In this case, the prediction target data from the sensor unit 23 can be input all the time or can be input at each predetermined period. As shown in FIG. 14, the configurations related to the two other modes explained with reference to FIGS. 12 and 13 can be combined.

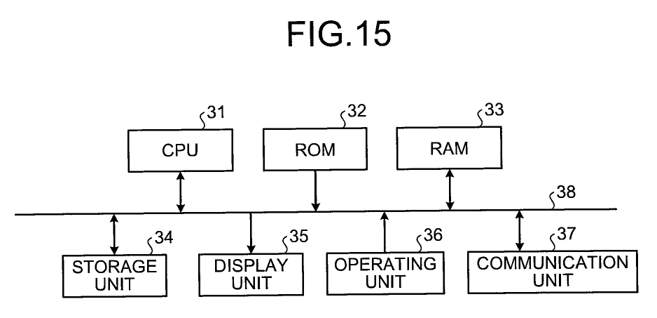

FIG. 15 depicts a hardware configuration of the time-series data analyzing apparatus shown in FIG. 1. As shown in FIG. 15, the time-series data analyzing apparatus includes a central processing unit (CPU) 31, a read only memory (ROM) 32, a random access memory (RAM) 33, the storage unit 34, the display unit 35, the operating unit 36, and the communication unit 37, and the respective units are connected with each other via a bus 38.

The CPU 31 uses the RAM 33 as a work area to execute various processes in cooperation with a program stored in the ROM 32 or the storage unit 34 and performs overall control of an operation of the time-series data analyzing apparatus. Further, the CPU 31 realizes the respective functional units (the data integrating unit 13, the parameter input unit 15, the event sequence generator 16, the prediction model generator 17, the time-series predicting unit 20, and the result display unit 21) in cooperation with a program stored in the ROM 32 or the storage unit 34.

The ROM 32 unrewritably stores a program or various pieces of setting information associated with the control of the time-series data analyzing apparatus. The RAM 33 is a volatile memory such as a synchronous dynamic random access memory (SDRAM) or double data rate (DDR) memory, and functions as a work area for the CPU 31.

The storage unit 34 includes a magnetically or optically recordable recording medium, and rewritably stores a program or various pieces of setting information associated with the control of the time-series data analyzing apparatus. The storage unit 34 functions as the history-data storage unit 11, the time-invariant-data storage unit 12, the integrated-data storage unit 14, the prediction-model storage unit 18, the target-data storage unit 19, and the analysis-target-data storage unit 22 by a storage/management mechanism such as a database included in the storage unit 34. The storage unit 34 is not limited to a single recording medium, and can be a plurality of recording media provided corresponding to an application or can be an external recording medium connected via a network or the like.

The display unit 35 includes a display device such as a liquid crystal display (LCD), and displays characters and images under the control of the CPU 31.

The operating unit 36 is an input device such as a mouse and a keyboard, and receives information input by the user as an instruction signal to output the information to the CPU 31.

The communication unit 37 is an interface that communicates with an external device, and outputs the various elements of data received from the external device to the CPU 31. The communication unit 37 transmits the various pieces of information to the external device under the control of the CPU 31.

While an exemplary embodiment of the present invention has been explained above, the present invention is not limited thereto, and various changes, substitutions, and additions can be made without departing from the scope of the invention.

For example, the program executed by the time-series data analyzing apparatus according to the above embodiment is assumed to be provided by being incorporated in the ROM 32 or the storage unit 34 in advance. However, the present invention is not limited thereto, and the program can be stored in a computer-readable recording medium, such as a compact disc-ROM (CD-ROM), a flexible disk (FD), a CD-recordable (CD-R), or a digital versatile disk (DVD) as a file of an installable format or an executable format and provided.

Further, the program can be stored in a computer connected to a network such as the Internet and then downloaded via the network and provided, or the program can be provided or distributed via a network such as the Internet.

In the above embodiment, a mode in which the time-series data analyzing apparatus is used for the quality control or maintenance sector of predetermined devices (parts) has been explained. However, applications the present invention are not limited thereto, and the time-series data analyzing apparatus can be used for time-series analysis of health examination data in medical, health, and nursing care sectors or can be used for analyzing the time-series data associated with other fields.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A time-series data analyzing apparatus comprising:
a first storage unit that stores integrated data obtained by associating time-series data and time-invariant data with respect to a common analysis target for each of a plurality of analysis targets, the time-series data recording an event item quantitatively indicating a predetermined event occurred with a lapse of time, a time-varying item indicating a numerical value of an element related to occurrence of a corresponding event, and date and time of occurrence of the event, and the time-invariant data including one or a plurality of time-invariant items indicating a time-invariant setting content relating to the analysis target;
a first generating unit that expands a numerical range of the time-varying item included in a specific set of integrated data to be analyzed, among sets of grouped integrated data for each of the analysis targets, and generates an event sequence expressing the numerical range including an amount of change of the time-varying item included in the set of grouped integrated data for each of other analysis targets;
a second generating unit that classifies respective sets of the grouped integrated data based on an inclusion between the amount of change of the time-varying item included in the sets of grouped integrated data and the numerical range expressed by the event sequence and also based on the time-invariant item common to respective sets, and generates a prediction model obtained by associating a prediction-target event sequence with the event sequence together with a classification condition related to the classification, the prediction-target event sequence expressing an amount of change of the event item included in each set of integrated data after being classified and an amount of time required for reaching the amount of change of the event item; and
a second storage unit that stores the prediction model.

2. The apparatus according to claim 1, wherein the first generating unit selects a plurality of the integrated data of a corresponding analysis target for each of common analysis targets from the integrated data stored in the first storage unit, and rearranges the integrated data in order of date and time of occurrence to group the integrated data.

3. The apparatus according to claim 1, wherein the first generating unit gradually expands the numerical range until number of grouped analysis targets satisfying a condition of the numerical range becomes equal to or larger than a predetermined number.

4. The apparatus according to claim 1, wherein the second generating unit classifies the prediction-target event sequences by using a decision tree classification model in which the event sequence is set as a route.

5. The apparatus according to claim 4, wherein the second generating unit repeats to classify the prediction-target event sequences until number of prediction-target event sequences, which are leaf nodes, becomes a predetermined number.

6. The apparatus according to claim 1, wherein the second generating unit calculates a difference in date and time of occurrence between the event items included in the sets of grouped integrated data as an amount of time required for each set of the classified integrated data, and designates a statistic of the amount of time required in each set of the integrated data as the amount of time required.

7. The apparatus according to claim 1, wherein
the time-series data includes the time-varying item of a plurality of elements different from each other,
the first generating unit generates the event sequence for each element of the time-varying item, and
the second generating unit generates the prediction model for each of the event sequence.

8. The apparatus according to claim 1, further comprising a display unit that displays a prediction model stored in the second storage unit.

9. The apparatus according to claim 1, further comprising a predicting unit that compares the time-series data and the time-invariant data of the prediction target with the classification condition in the prediction model, and derives an amount of change and an amount of time required of the event item expressed by the prediction-target event sequence, which is reached finally, as a prediction result, wherein the display unit displays a derived prediction result.

10. The apparatus according to claim 1, further comprising:
a third storage unit that stores the time-series data;
a fourth storage unit that stores the time-invariant data; and
an integrating unit that integrates the time-series data stored in the third storage unit and the time-invariant data stored in the fourth storage unit with respect to a common analysis target included in the time-series data and the time-invariant data, wherein
the first storage unit stores data integrated by the integrating unit.

11. A time-series data analyzing method comprising:
storing integrated data obtained by associating time-series data and time-invariant data with respect to a common analysis target for each of a plurality of analysis targets, the time-series data recording an event item quantitatively indicating a predetermined event occurred with a lapse of time, a time-varying item indicating a numerical value of an element related to occurrence of a corresponding event, and date and time of occurrence of the event, and the time-invariant data including one or a plurality of time-invariant items indicating a time-invariant setting content relating to the analysis target;
expanding a numerical range of the time-varying item included in a specific set of integrated data to be analyzed, among sets of grouped the integrated data grouped for each of the analysis targets, and generating an event sequence expressing the numerical range including an amount of change of the time-varying item included in the sets of grouped integrated data for each of other analysis targets; and
classifying respective sets of the grouped integrated data based on an inclusion between the amount of change of the time-varying item included in the sets of grouped integrated data and the numerical range expressed by the event sequence and also based on the time-invariant item common to respective sets, and generating a prediction model obtained by associating a prediction-target event sequence with the event sequence together with a classification condition related to the classification, the prediction-target event sequence expressing an amount of change of the event item included in each set of grouped integrated data after being classified and an amount of time required for reaching the amount of change of the event item.

12. A computer program product having a computer readable medium including programmed instructions for analyzing time-series data, wherein the instructions, when executed by a computer, cause the computer to perform:
storing integrated data obtained by associating time-series data and time-invariant data with respect to a common analysis target for each of a plurality of analysis targets, the time-series data recording an event item quantitatively indicating a predetermined event occurred with a lapse of time, a time-varying item indicating a numerical value of an element related to occurrence of a corresponding event, and date and time of occurrence of the event, and the time-invariant data including one or a plurality of time-invariant items indicating a time-invariant setting content relating to the analysis target;
expanding a numerical range of the time-varying item included in a specific set of integrated data to be analyzed, among sets of grouped integrated data for each of the analysis targets, and generating an event sequence expressing the numerical range including an amount of change of the time-varying item included in the sets of grouped integrated data for each of other analysis targets; and
classifying respective sets of the grouped integrated data based on an inclusion between the amount of change of the time-varying item included in the sets of grouped integrated data and the numerical range expressed by the event sequence and also based on the time-invariant item common to respective sets, and generating a prediction model obtained by associating a prediction-target event sequence with the event sequence together with a classification condition related to the classification, the prediction-target event sequence expressing an amount of change of the event item included in each set of grouped integrated data after being classified and an amount of time required for reaching the amount of change of the event item.
